(19) United States
(12) Patent Application Publication
(10) Pub. No.: US 2022/0092974 A1
(43) Pub. Date: Mar. 24, 2022

(54) TRAFFIC STRATEGY SYSTEM AND METHOD OF IMPLEMENTING THE SAME

(71) Applicant: SIMPLIFAI SYSTEMS LTD, Huddersfield (GB)

(72) Inventors: Keith McCabe, Huddersfield Yorkshire (GB); Lee McCluskey, Huddersfield Yorkshire (GB); James Blackwood, Huddersfield Yorkshire (GB); Mauro Vallati, Huddersfield Yorkshire (GB)

(21) Appl. No.: 17/422,996

(22) PCT Filed: Jan. 14, 2020
(86) PCT No.: PCT/EP20/50815

§ 371 Date: Jul. 14, 2021

(30) Foreign Application Priority Data
Jan. 14, 2019 (GB) 1900503.2

(51) Int. Cl. G08G 1/09; G08G 1/01

(52) U.S. Cl. CPC G08G 1/094; G08G 1/0145; G08G 1/0125; G08G 1/093

(57) ABSTRACT

A traffic strategy and/or management system suitable for generating and/or implementing strategy options which achieve a goal set by the user, said system including orchestration means connected to; data source means, infrastructure means and management or control means. The orchestration means is also connected to a strategy generation means configured to create at least one traffic management strategy and/or a set of control instructions for all infrastructure means relevant to the strategy to achieve a goal set by the user, wherein said data source means includes modelled data and real time data which are supplied and utilised by the strategy generation means and received via the orchestration means to create a traffic management strategy and/or a set of control instructions in real time and/or near real time.

Transport networks are complex with many interactions between users of the networks. Transport network operators try to maintain flows of people and goods around the network in the most efficient ways possible.

Traditionally road networks are managed using a variety of forms of traffic technology namely: traffic signals, message signs, travel apps, pricing and incident management teams and systems.

These systems and methods work well when the travel demand is less than the capacity of the networks to service the demand.

When the travel demand approaches network capacity on a regular basis, forms of adaptive control are introduced. In traffic control the systems manage the flows in an optimum way to minimise congestion and reduce delay. This operation is normally performed on a transport corridor by corridor basis or in a small geographical region typically less than 4 km². These systems perform well providing the capacity of the network links is not exceeded and there are no incidents that reduce the capacity of particular links for more than a short period of time.

When incidents occur, the network operators intervene to clear the incident with local incident management teams and inform travellers on the network of potential disruption. Occasionally the control systems are employed to create different flows around the incidents, however, for this action to take place similar incidents would have needed to occur previously with a suitable plan being generated to deal with that incident (either at the time of during post incident analysis).

Customized plans are often created to deal with planned major incidents, roadworks or major events. These plans are normally manually constructed using modified versions of traffic model typical road conditions. These plans take significant amounts of time to create and may require real time refinement if the actual conditions significantly diverge from the one created in the traffic models.

The present invention addresses the abovementioned problems by using an automated method for the creation of network management plans than can be generated and implemented in real time or generate plans off line and test them in models prior to implementation.

The present invention is goal driven software that uses its understanding of how the surface transport network work to investigate all possible options on the route to finding an option that achieves the goal set by the transport operators.

The present invention can address the following issues in real time:
Event management—where a large event is planned to occur at a particular time, The present invention combines the known information about the event (time of event, nature of event, likely levels of travel demand) with real time knowledge of the network status to produce travel plans to manage the events.
Roadworks management—during roadworks The present invention takes the knowledge to the capacity reduction caused by the roadworks and combines that with the real time and predicted demands for up to a 60-minute time horizon to produce traffic management plans to reduce the congestion in the area of the roadworks and reduce to consequential effects of the bottleneck caused by the roadworks.
Incident management—this is similar to the roadworks management the present invention takes the knowledge of the capacity reduction caused by the incident (lane closure/road closure) and combines it with the knowledge of the current and predicted demands for up to an hour to produce plans to reduce the congestion and consequential effects caused by the incident.
Air quality management—The present invention produces traffic management plans in real time to reduce the emission in the locations that have the highest levels of air pollution. The present invention combines the knowledge of the current travel demands with a knowledge of the network capacities and a calculation of the link by link emissions. This knowledge is then used to reduce the emissions in the areas where the monitored or modelled air pollution is likely to be high.
Bottleneck management—The present invention uses its knowledge of the network demands and capacity pitch points to manage the pinch points through forms of upstream gating and local rerouting to ensure that key network bottlenecks are operated at or below capacity. This ensures that the consequential delays caused by bottlenecks do not result in Gridlock for areas of the network.

In a first aspect of the invention there is provided a traffic strategy and/or management system suitable for generating and/or implementing one or more strategy options which achieve a goal set by the user, said system including orchestration means connected to;
at least one data source means,
at least one infrastructure means; and
at least one management or control means characterised in that said orchestration means is also connected to a strategy generation means, said strategy generation means configured to create at least one traffic management strategy and/or a set of control instructions for all infrastructure means relevant to the strategy to achieve a goal set by the user, wherein said data source means includes modelled data and real time data which are supplied and utilised by the strategy generation means and received via the orchestration means to create at least one traffic management strategy and/or a set of control instructions.

In one embodiment the traffic is road based traffic.

In one embodiment the data source means include any one or any combination of traffic management and control systems, data aggregation hubs, databases, smart city data sources and sensors of any kind, including connected vehicles and sensors thereof. Typically data from the data source means can be provided manually and/or automatically. Further typically the system uses multiple data input means.

In a preferred embodiment the system includes one or more input data adaptors. Typically the input adaptors collect and/or process information from the at least one data source means into the correct form for use by the strategy generation means. Further typically the input data adaptors collect and/or extract the information from the data source means securely.

Typically multiple input adapters are used by the system to extract data from a plurality of data source means.

In a preferred embodiment the system includes one or more output data adaptors. Typically the output adaptors process control instructions from the strategy generation means and processes the same into a format for use and/or execution by the infrastructure means. Further typically the output data adaptors execute any one or any combination of operations including; translation, adaptation, combination, completion, validation/verification and other forms of intermediate processing on the control instruction output from the strategy generation means.

Typically the system utilises multiple output data adaptors.

In one embodiment the infrastructure means includes real-time traffic control products. Typically the output data adaptors turns and/or adapts the control instructions issued by the strategy generation means into signal plans that can be loaded into the traffic control system. Further typically the signal plans are complete signal plans.

In a preferred embodiment of the invention the system includes one or more process control adaptors. Typically the process control adaptors are situated to control instruction and/or data flow into and/or out of the orchestration means. Further typically the process control adaptors include any one or any combination of functions including; issuing the correct instruction, in the correct way, in the correct format, at the correct time to the correct infrastructure means, determining the effect of an instruction through data source means and measurement, before, during and after instructions have been issued, and determining that an instruction has been successful and responding to problems, including external problem reporting.

Typically control adaptors are used both for input and output. For example inputs include requesting real-time information about parking availability or traffic volume. Outputs include instruction for controlling signals, issuing routing guidance to connected vehicles, etc.

In one embodiment the control adaptors have a user interface. In one embodiment the control adaptors may be part of another product and/or system. For example in one embodiment, a traffic simulation control adaptor is embedded within the traffic modelling and simulation product of a third party, with a user interface that allows configuration and control of the particular adaptor.

In a preferred embodiment the orchestration means orchestrates the set of control instructions produced by the strategy generation means across the components or means of the system. Typically orchestration includes collection, coordination, and sending instructions from the strategy generation means to at least the infrastructure means. Further typically the orchestration is in real-time. Preferably the control instructions are orchestrated across systems in real-time, for a period of time, until the strategy is successful and/or is replaced with second or further strategies.

In one embodiment the orchestration means continuously compares real-time data from data source means with anticipated traffic flows using input data adaptors. Typically the orchestration means compares real-time with anticipated traffic flows using input data adaptors and the strategy generator mean's output so that it can trigger implementation of a new strategy, or calculation of a new strategy, when there is divergence. Further typically, said orchestration means converts signal instructions into a collection of signal plans.

In one embodiment the signal plans are loaded, executed and/or unloaded in the correct sequence from control adaptors. Typically the orchestration means converts signal instructions into a collection of complete signal plans, which it can load, execute and unload from single or multiple traffic controllers using a traffic control computer.

In one embodiment the orchestration means provide accurate, timely information to the management or control means. Typically the management or control means is in a supervisory control environment in a traffic control centre.

Preferably, the system can be configured to operate independently and/or operate as an integrated part of another traffic management product. In such an embodiment the system provides a set of data and control interfaces that can be used by other systems to configure and control the system, or to present options and information to users.

In one embodiment the system includes a control or management means in the form of a management console application. Typically the control or management means provides any, or any combination of configuration, management, control, visualisation and reporting facilities. Thus allowing the strategy generator to operate either as a decision support tool via human-initiated control, or as an autonomous traffic management product via system-initiated control.

In one embodiment a user can utilise a traffic management console or application to set a goal for the strategy generator. Typically the console can then run the strategy generator, visualise the resulting strategy, execute the strategy, evaluate its effectiveness in real-time, stop the current strategy, generate a new strategy and/or report/evaluate its effectiveness post-completion. Further typically the console can configure operational parameters, adaptor integrations, data sources/sinks and/or security options.

In a preferred embodiment the strategy generation means inputs include an initial state at some time (T), a goal, a domain model, and a time delay (E). Typically the strategy generation means it outputs a traffic signal strategy that if said strategy is executed at time T+E to the initial state, it will achieve the goal.

Typically an initial state is the set of all the data/knowledge about the traffic scenario within a spatial target region of an area under consideration.

In one embodiment only certain or predetermined initial states are allowed. Preferably the initial state comprises two types of information, persistent data and real time data. Typically persistent data is collected or known before strategy generation. Further typically real-time data is data from the target region that is collected instantaneously, in real time and/or near real time.

In one embodiment persistent data comprises any one or any combination of, including all of; a unique identifier for every link, junction, and junction stage in the problem target region.

Typically the set of all links is made up from a disjoint union of sets of links including; in-link U internal-link U out-link. Further typically in-links and out-links are collectively termed boundary-links and have one end which is outside the region under consideration. Otherwise a link is an internal-link.

In one embodiment persistent data includes maximum storage capacity of each link in pcu (a standardised unit of vehicle). Typically all boundary links are assumed to have infinite capacity.

In one embodiment persistent data includes for each signalized junction any one or any combination of; stage orders (fixed sequential ordering of signal stages), fixed signal intergreen timings between stages, recommended maximum cycle time of junctions. Typically pedestrian crossings are considered signalized junctions modelled as having one stage (when traffic flows) and one intergreen (when pedestrians can cross).

In one embodiment persistent data includes for each stage in a signalized junction any one or any combination of; which turning movements (left, right & straight on) is/are shown a green signal during that stage, minimum time of the stage, a maximum time of the stage, and/or for each turn, the estimated maximum physical flow in pcu/s, typically for the turn during that stage.

In one embodiment persistent data includes for each turn an estimate of the stage average flow in pcu/s. Typically the estimate is for the period of time used for the plan (am peak, off peak, pm peak, special event etc) to be planned for, based on origin-destination of the traffic entering the region. Further typically this value will be used during pre-processing to extract the intentions of the vehicles from the simulation software.

In one embodiment persistent data includes for each turn in a non-signalized junction, the maximum flow in pcu/s

Typically the existence of a ‘turn’ at a junction means two named links are joined, and therefore implicitly gives the network topology of the targeted region.

In one embodiment persistent data includes for each in-link, the expected average flow rate in pcu/second feeding into that link. Typically this can be ‘step-changed’ over periods of time (so for a link in, we may expect 1 pcu/s average for 120 seconds, then 0.5 pcu/s average for the next 60 seconds, etc). Further typically out-links are assumed to act like sinks, so that traffic flows into them unimpeded from the end of the link inside the region.

In one embodiment persistent data includes a fixed plan stating, for each junction, how many seconds green time each stage will be active before entering intertime. Typically the fixed plan has a fixed cycle time, and a fixed set of split timings, and is assumed to be the plan active in the targeted region at time T when the strategy generator is invoked.

In one embodiment persistent data includes the goal what the generated strategy has to achieve as efficiently or quickly as possible. Typically, the goal must be written as a logical term whose components are data that the generated strategy can change. Further typically, possible goal components are those that can be defined in terms of the effects of a process, action or event in the domain model. An example goal might be to lower the occupancy of a set of links.

In one embodiment real-time data includes the number of vehicles (in pcu(s)) in each link at time T.

In one embodiment real-time data includes, for each signalized junction, the identifier of the current green lit stage or intergreen active at time T, and the number of seconds elapsed since the beginning of that stage or intergreen.

In one embodiment the strategy generation means generates split timings for junctions in the region of interest. Typically, in contrast to the fixed time plan, these splits may vary over the time of the plan, as may the cycle time of a junction, within the limits of any given maximum cycle time. Further typically this assumes a stage of signals at a junction is defined as a distinct set of signals that are continuously showing green.

Typically, each stage is followed by a fixed length intergreen, of 0 or more seconds. Further typically there are some special cases: a filter arrow entails a 0s intergreen time (the next stage starts immediately). A pedestrian crossing consists of 1 stage and 1 intergreen. A junction with no signals consists of 1 stage.

In one embodiment for all junctions in the region, for each cycle over time, the strategy generation means will produce a signal plan of split timings in order to achieve the goal it is given.

In one embodiment the strategy generation means works in two phases, a pre-processing phase and a heuristic phase.

Typically, in order to generate a strategy to achieve the goal, and check that the strategy will achieve the goal, the strategy generation means includes a simulator or a planning engine that includes a simulator.

Typically the simulator simulates the operation of a strategy on the initial state, using the active elements of the domain model. Further typically the simulator simulates the operation of a strategy using the processes, actions and events defined therein.

The simulation of the traffic world is digital; therefore, in one embodiment we typically need a unit (or, a ‘delta’) after which an incremental change will be simulated. In this case, we use delta=1 second intervals. The key flow value required for simulation is estimated as the volume of vehicles (in pcus) travelling along a route from link X to link Y through a junction. This actual flow rate (AFR) used in the strategy generation means' planning engine's simulation is calculated at each time T.

For calculating the AFR[T], we use the maximum physical flow rate (PFR) as the root.

AFR[T] is calculated from the application of the following functions to PFR:

AFR[T]=PFR×G1×G2×G3×G4×G5

Where:

G1=factor derived from saturation of X at time T

G2=factor derived from saturation of Y at time T

G3=factor derived from any cross flows of X to Y (e.g. if X to Y is a right turn) at time T

G4=factor derived from intentions of drivers, extracted from the stage average turn rate

G5=length of time the stage has been activated at time T

Given the AFR is calculated thus at time T in state S(T), we can specify the simulator by specifying what changes it makes to the State at time T, given a generated (or pre-defined) strategy P, as specified in the simulation routine, steps 1-5, below.
1. From P, collect all the actions that must be executed from state S(T) (i.e. timed to execute at T) then sequentially execute them. The sequence of execution of each action must make no difference to the effect. Let the resulting updated state=S1(T).
2. Run the procedure Events(S1(T),S2(T)).
3. Collect all the processes from the domain model that have their preconditions satisfied in state S2 then sequentially execute them for Delta time. The sequence of execution of each process must make no difference. Additionally, no events' preconditions can become true during Delta then become false again. Let the resulting updated state=S3(T+Delta).
4. Run the procedure Events(S3(T+Delta),S4(T+Delta)).
5. End

The procedure Events(s,t) inputs a state s and outputs a state t, as follows:
1. Collect all the events from the Domain Model that have their preconditions satisfied in state s then sequentially execute them. The sequence of execution of each event must make no difference to the effect. Let the resulting updated state=s1.
2. IF s is not equal to s1 THEN set s:=s1 and goto 1; ELSE set t:=s1.
3. End

For the full simulation, we iterate through the simulation routine above starting with T=0, replacing S with S4(T+Delta) and T with T+Delta after each run, until we have reached the end of P.

In one embodiment the strategy generation means inputs need to be pre-processed. Typically the pre-processing phase provides a form of static validation which checks the integrity or otherwise of the input data. Further typically the pre-processing optimises their representation, making explicit information within the problem that the strategy generator may need to use multiple times; and/or transforms the inputs into a more efficient representation involving reduction of dimensions on predicate arguments.

In one embodiment the pre-processing phase has at least three steps.

Typically step 1 includes a check that the invariants are all met. If any are violated, then the strategy generated may be unreliable

Typically step 2 includes for every junction and link, the following are calculated;

Let C be any allowed set of timings for stages in a signalized junction (i.e. set of stage time lengths that are between the max and min allowed); L,L1,L2 links, and j a junction. Then we calculate the following using simulated flow values (i.e. where the flows are the estimated maximum flow values for the period under simulation):

F1ⱼ(L1,C)=the average outflow over C emerging from the end of link L1 through j;

This is the amount of traffic that escapes from L1 on average over the whole of the cycle C as specified.

F2ⱼ(L2,C)=average inflow into the start of L2 through j over the whole of the cycle C;

F3j(L1,L2,C)=average inflow over cycle C from link L1 into the start of L2

Note we have the connection that that the sum over all links L leading into L2 (i.e. sum of F3j(L,L2,C) over all L) is equal to F2ⱼ(L2,C).

Then we can calculate the ‘average fill-up rate’ of a link L as:

F2j(L,C)−F1ₖ(L,C1)

where L is a link from junction j to junction k, and C1 is any allowed set of timings for stages in junction k.

Given these definitions we can calculate the main expected flow corridors through the region from an in-link to an out-link, where the majority of vehicles proceed.

There are typically three sets of outputs from step 2 as follows;
Output 1
The first step is, for any given junction j, to calculate the timings of stages which maximize the flow out of a particular link L that feeds into j. We call this set of timings Cmax(L). Note we do not need to refer explicitly to ‘j’ as we assume every link flows into a unique junction.
In the context of the presence of a maximum cycle time for each junction (rather than using maximum timing for each stage, as carried out in our earlier work; If there are maximum timings for individual stages, as well as a maximum cycle time, then the calculation of optimum stage timings is more detailed.) Cmax(L) is calculated by maximizing the stage time of the stage with the largest flow out, and minimizing the rest:
To determine a stage time of s in Cmax(L):
IF s guarantees the greatest flow out of L THEN

Stage time of s:=(maximum cycle time)−(addition of minimum timing of all other stages)−(addition of all inter green times) ELSE
Stage time of s:=minimum stage time of s.
So for example if we have a max stage time of 120, 3 intergreens of 10 s and mins of 10 s for each of 3 stages s1,s2,s3, and flow out of L during s1=1.0 pcu/s, s2=0.9 pcu/s and s3=0.1 pcu/s, then Cmax(L) is: Stage time of s1=70 s, Stage time of s2=10 s, Stage time of s3=10 s, and hence the average outflow of L over a cycle under Cmax(L) will be 0.666 pcus/second.
The pre-processor calculates Cmax(L) for each link L.
Output 2
Given a link L1, the pre-processor calculates the ‘goal corridor’ from L1—this is the list of links which traces the largest expected flow from L1 through the network to a out-link (which is considered to act as a sink), using junction stage timings that give the maximum flow out of each link, calculated in output 1 above.
To calculate the goal corridor from L1 which flows into junction j1, use the following procedure:
1. WHILE L1 is not an out-link:
2. identify L2, the next link in the corridor, where F3ⱼ₁(L1,L2,Cmax(L1)) maximizes function F3ⱼ₁(L1,LX,C), with LX ranging through all the links flowing out of j1.

3. set L1: L2

4. END WHILE
Hence, each link is in the goal corridor because it is the link that receives the highest average flow over a cycle from its predecessor.
Output 3
Given a link, the pre-processor calculates all the bottlenecks along a goal corridor, that is the set of links where the average fill-up rate (defined above) is positive.

In one embodiment in step 3 this algorithm shows how the reformulation of a domain model Dₒ and an initial state and goal expression Iₒ is performed. Beside the models to be reformulated, the algorithm requires as input a sparsity threshold sₜ which is used to decide whether or not it is useful to perform the reformulation and a parameter at which sets the maximum number of variables considered in the reformulation.

The output is a new domain(Dᵣ) and problem(Iᵣ) description with a reduced dimensionality, which makes the use of strategy generation software more efficient.

Typically we consider predicates of a domain model as static if instances of the predicate cannot be deleted or created during the planning process but, in the case of numeric predicates, their value can be changed. The sparsity of the predicates (boolean or numeric) with arity greater than 2 are assessed in turn (line 3) to determine if they are suitable for the reformulation step. As a measure of sparsity, we compare the set of propositions in the initial state with the possible set of all propositions for the predicate.

Input: Dₒ, Iₒ, sₜ , aₜ
Output: Dᵣ ,Iᵣ

| | |
|---|---|
| 1 | SP = statics(Dₒ ); P = predicates(Dₒ )∪functions(Dₒ) |
| 2 | Dᵣ = Dₒ ; Iᵣ = Iₒ |
| 3 | FOR ALL pⱼ in P , where arity(pⱼ ) > 2 DO |

| | |
|---|---|
| 4 | IF sparsity(pⱼ , Iₒ ) > sₜ THEN |

| | |
|---|---|
| 5 | pₛₜₐₜ = findConstrainingStatic(pⱼ,SP) |
| 6 | IF pₛₜₐₜ is not equal to None THEN |

| | |
|---|---|
| 7 | Tpₛₜₐₜ = getSparseVariables(pₛₜₐₜ ,Iₒ,aₜ) |
| 8 | Cnew =makeConstants(Tpₛₜₐₜ , sₒ ) |
| 9 | Dᵣ = addAsConstants(Dᵣ , Cnew ) |
| 10 | Dᵣ = updateOpProEv(Dᵣ , Tpₛₜₐₜ , Cnew ) |
| 11 | Iᵣ = updatePredsFuncs(Dᵣ,Iᵣ,Tₚₛₜₐₜ ,Cnew ) |

| | |
|---|---|
| 12 | END IF |

| | |
|---|---|
| 13 | END IF |

| | |
|---|---|
| 14 | END FOR |

15

In the case of a sparse predicate pi the procedure attempts (line 5) to find a static predicate pₛₜₐₜ such that pi is only used in transition schemas (that is in the action, process or event schemas) with pₛₜₐₜ. If there is more than one constraining static predicate, then one is selected heuristically by selecting the predicate that occurs the most in transition schemas.

In one embodiment the strategy generation means includes a heuristic phase. Typically to make strategy generation efficient and effective in any large hybrid application, a “heuristic” for the application is generated and used to guide the search in this search space. Further typically a heuristic helps guide the search, but it is not a hard rule, i.e. the search will try first those states for which the heuristic gives the lowest values, but if a solution is not found, it will progressively try states with higher values until a solution is found.

In one embodiment any hybrid AI Planner can be used in the method, as long as it allows such a domain—dependent heuristic to be inserted in its search strategy. Typically, automated planning engines which accomplish this for hybrid (i.e. discrete and continuous) formulations input a language equivalent to a community accepted syntax called PDDL+.

In a preferred embodiment the strategy generation means employs corridor heuristics.

Typically the general formulation for corridor heuristics are aimed at generating strategies for goals concerning the lowering of the occupancy of a link or of a set of links.

In one embodiment for a link L1 in this goal set, the first step in the process is to generate the goal corridor of L1, as defined above in the pre-processor section, consisting of junctions j1 . . . jN and Links L1 . . . LN:

L1−j1−L2−j2−L3− . . . −LN−jN

where for each junction j we have cycle Cmax(Lj) operating. This cycle assignment will lead to bottlenecks, however, as some links will become saturated.

Hence, the heuristic we require will be equivalent to an assignment of adjusted cycles C1, . . . CN under the constraints:

$$F {2}_{j 1} ( L 2 , C 1 ) - F {1}_{j 2} ( L 2 , C 2 ) < E 1$$

$$F {2}_{j 2} ( L 3 , C 2 ) - F {1}_{j 3} ( L 3 , C 3 ) < E 2$$

$$F {2}_{j 3} ( L 4 , C 3 ) - F {1}_{j 4} ( L 4 , C 4 ) < E 3$$

$$… . \\ F {2}_{jN - 1} ( LN , CN - 1 ) - F {1}_{jN} ( LN , CN ) < EN$$

where EI,1 1=<I=<N, is the allowed extra flow into a link LI+1, taking into account the length of LI+1

Where we have a set of links to be lowered in the Goal, we can sum the individual values of the heuristic for each link in the set.

In one embodiment a specific corridor heuristic is calculated as follows:
1 Calculate the bottlenecks of the corridor. Note that there can be several bottlenecks, each of them affecting all links in the corridor which are closest to the goal than the corresponding bottleneck. Assume the first bottleneck is in link Lk, where we have:

L1−j1−L2−j2−L3− . . . Lk−1−jk−1−Lk−jk
2 Adjust the cycle times in the goal corridor for the junctions j1 to jk−1 so that the maximum average flow is never bigger than the bottleneck. This is achieved by lowering the maximised stage times in the goal junctions up to jk−1. This is implemented by reducing the time of the stage with the biggest average flow.

Typically this is an approximation to the general formulation above. The distance from the bottleneck to any link ‘upstream’ does matter, e.g. a link which is a direct neighbour should reduce its average flow to exactly the pcus the bottleneck can take.

Further typically, if there is more than one link distance, reduction of flow should be adjusted to take into account that not all vehicles will actually make it to the bottleneck.

For example, if we have corridor links L1, L2 and L3, L3 is the bottleneck, and L1->L2->L3, then the effect of L3 in reducing corridor output flow of L1 is ameliorated by the fact that cars leaving L1 to L2 might actually not make it to L3 because they are leaving the corridor.

These corridor heuristics are under constrained, which means that there are choices on how the maximised timings at each junction are calculated. Hence, they can be adjusted to take into account other constraints on the region, such as the need to provide a minimum cross corridor flow over some junctions, or where we have more than one link in the goal set.

In one embodiment the penalty-based corridor heuristic is used. Typically this is an extension of the corridor heuristic. It adds a penalty to the calculation of the heuristic for any state found whose goal(s) stage times are past the corridor heuristic regulated values. This way, search will always test first state(s) whose goal junctions are not sending more flow through than what the bottleneck can process on average.

In one embodiment an expanded penalty-based corridor heuristic is employed. Typically this heuristic penalizes not only states whose goal junction phases are past the corridor heuristic times, it also penalizes if any of the corridor's junction phases are past their corresponding time values (as if we assessed them with the same corridor-based heuristic methodology we used for the goal(s) junctions).

In one embodiment the strategy generated by strategy generation means is post-processed. Typically the post-processing is into a convenient format, and output to file. Further typically processes requiring this generated strategy will read it from this file.

An embodiment of a format of a strategy is given below. In this example, it specifies stage time changes, i.e. when to move on from the current stage, for all of the signalized junctions (excluding pedestrian crossings, which are assumed to have fixed stage times).

In one embodiment the syntax of the control strategy is as follows. The file is a list of lines of the form:

<action number><time><stage id>

e.g.

11 140 s1202_s4

This means at <time>=T+E+140 seconds (140 seconds from the start of the strategy) move the signal at stage <stage_id>=s1202_s4 on to the next stage (the next stage will be reached after a specified intergreen time, of course). The <stage id> is unique to a particular junction, hence there is no need to include the junction identifier here. The action number here=11.

An external simulator that inputs this strategy, progresses its simulation using only these signal changing actions in the region (the strategy should direct every signal change). At the end of the signal strategy, the simulator should revert to its default strategy.

A short strategy for a region containing two junctions (N1202 and N1349, with specification below) which starts when the greentime for stage s0=0 at both junctions, using this syntax, is:

1 20 s1202_s0

2 30 s1349-s0

3 30 s1202_s1

4 40 s1349_s1

5 40 s1202_s2

6 60 s1202_s3

At the end of this example strategy, at 60 seconds, both junctions return to the default strategy. Hence 1202 (which is beginning stage s4 at the end of the strategy) will run through stage s4 until the default strategy tells it to change.

At the end of the strategy, as 1349 is 15 seconds into stage s2 (taking into account 5 seconds of intergreen after s1), it will run until the default strategy tells it to change if the strategy says greentime for this stage is greater than 15 seconds. If the default strategy says greentime for this stage is less than or equal to 15 seconds, then it will immediately switch N1349 to stage s3 at the end of the strategy.

Specification of the junctions involved in the example are as follows:

(=(interlimit S1202_s0) 0)

((interlimit S1202_s1) 0)

((interlimit S1202_s2) 0)

((interlimit S1202_s3) 0)

((interlimit S1202_s4) 5)

((interlimit S1202_s5) 0)

((interlimit S1202_s6) 5)

((greentime N1202) 0)

((intertime N1202) 0)

((mingreentime S1202_s0) 5)

((mingreentime S1202_s1) 5)

((mingreentime S1202_s2) 0)

((mingreentime S1202_s3) 5)

((mingreentime S1202_s4) 5)

(_(mingreentime S1202_s5) 0)

((mingreentime S1202_s6) 5)

((maxgreentime S1202_s0) 40)

((maxgreentime S1202_s1) 20)

((maxgreentime S1202_s2) 10)

((maxgreentime S1202_s3) 60)

((maxgreentime S1202_s4) 70)

((maxgreentime S1202_s5) 15)

((maxgreentime S1202_s6) 50)

(active S1202_s0)

((interlimit S1349_s0) 5)

((interlimit S1349_s1) 5)

((interlimit S1349_s2) 10)

((interlimit S1349_s3) 10)

((greentime N1349) 0)

((intertime N1349) 0)

((mingreentime S1349_s0) 5)

((mingreentime S1349_s1) 5)

((mingreentime S1349_s2) 5)

((mingreentime S1349_s3) 10)

((maxgreentime S1349_s0) 70)

((maxgreentime S1349_s1) 70)

((maxgreentime S1349_s2) 70)

((maxgreentime S1349_s3) 75)

(active S1349_s0)

An explanation for some of these facts is as follows:

((interlimit S1202_s6) 5) means that the intergreen after stage S1202_s6 lasts for 5 seconds.

((greentime N1202) 0)

((intertime N1202) 0) means that the next stage at junction N1202 has not started yet.

(active S1202_s0) means that stage S1202_s0 is active, but it has just started (its elapsed green time is 0 seconds).

(_(mingreentime S1202_s0) 5) means that stage S1202_s0 must remain active for at least 5 seconds.

In a second aspect of the invention there is provided a traffic strategy implementation system which generates instruction for a transport network infrastructure which achieves a goal set by the user, said system including orchestration means connected to;

at least one data source means,

at least one infrastructure means; and

at least one management or control means

characterised in that said orchestration means is also connected to a strategy generation means, said strategy generation means configured to create at least one traffic management strategy and/or a set of control instructions for all infrastructure means relevant to the strategy to achieve a goal set by the user.

Preferably said data source means includes modelled data and real time data which are supplied and utilised by the strategy generation means and received via the orchestration means to create at least one traffic management strategy and/or a set of control instructions.

A specific embodiment of the invention is as follows, with reference to the following figures, wherein;

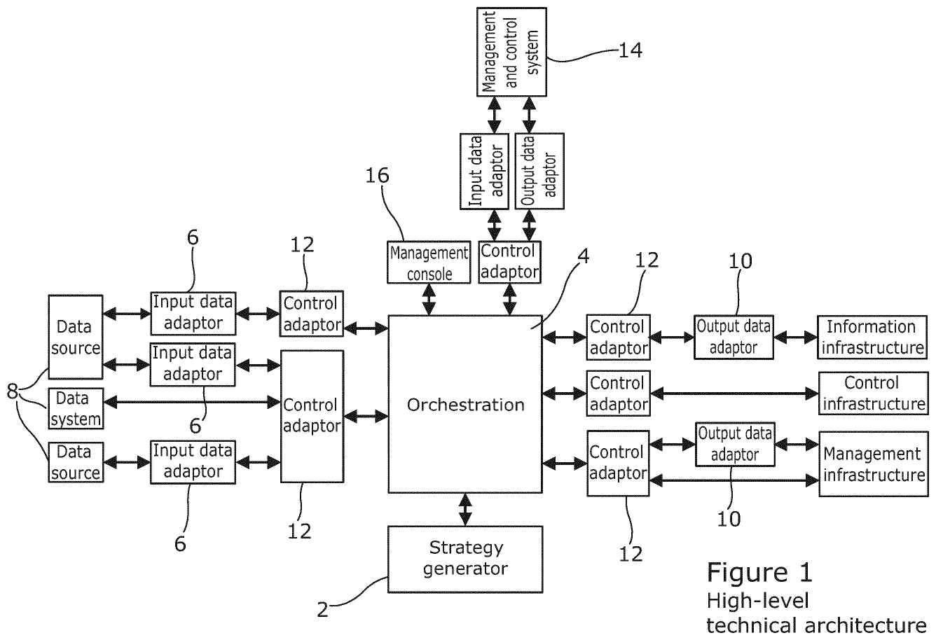

FIG. 1 shows a schematic of a high-level view of the technical architecture;

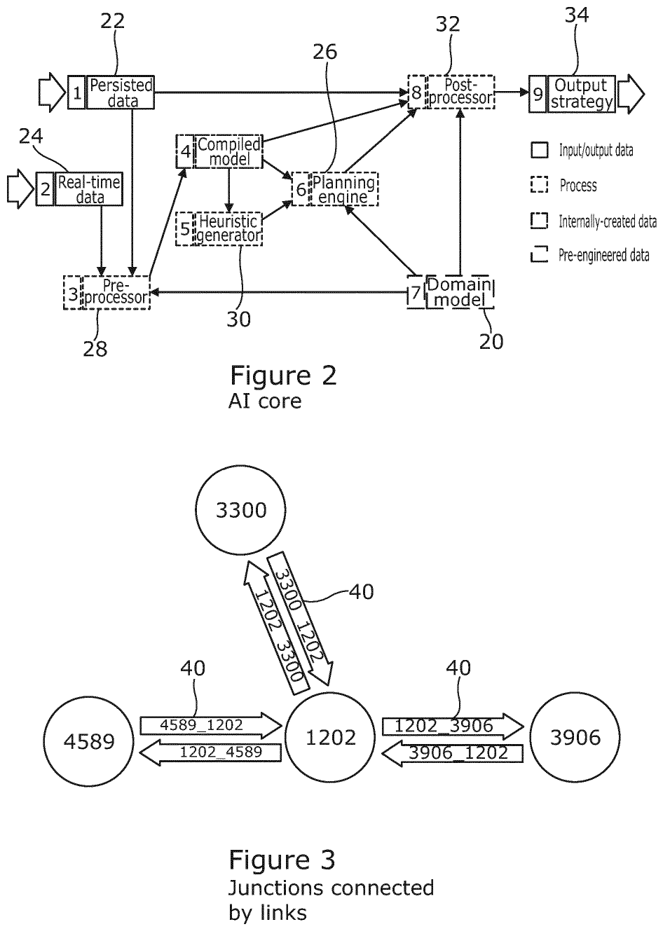

FIG. 2 shows a schematic of the artificial intelligence (AI) core in accordance with one aspect of the invention;

FIG. 3 shows a diagram of junctions connected by links;

FIG. 4 shows an example of a signal cycle at a junction; and

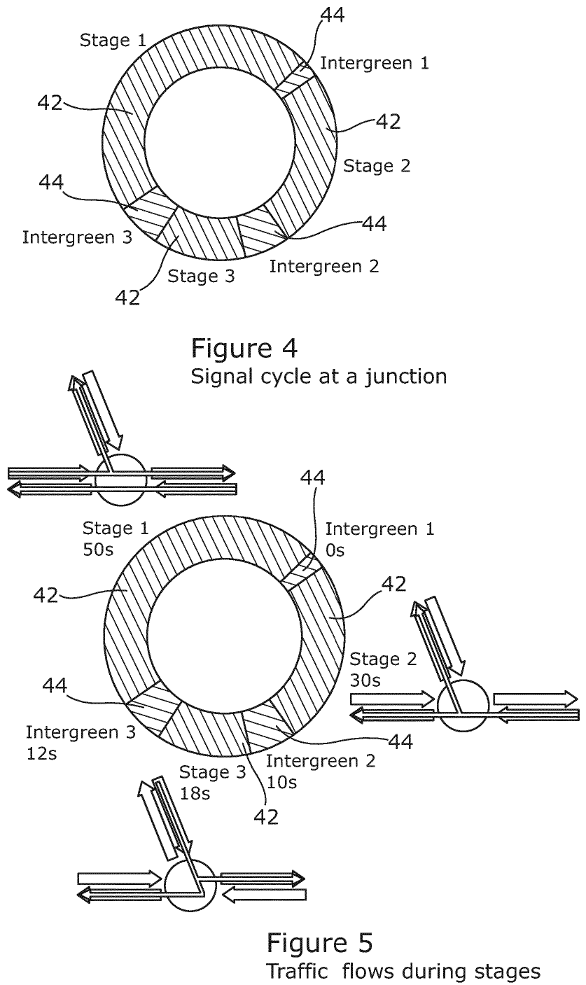

FIG. 5 shows a diagram of traffic flows during stages.

The present invention, referred to hereafter as the Simplifai System is a step change improvement from other Strategy Generators for Road Traffic Management in the following ways:
Scale of operation—Simplifai can work at a city-wide scale. Other systems typically work to optimise at a corridor or small region (typically less than 4 km²)
Speed of operation—Simplifai finds a strategy to meet the goal in less than a single traffic signal cycle time (>40 seconds). Current results show the production of a plan in less than 10 seconds. This means the outputs can be used in real time with a response time of less than 1 minute.
Ability to address a range of goals—existing systems have fixed goals of reduction of congestion in a particular corridor or region of a city. Simplifai can have a range of different goals to be achieved by the traffic management plan.
Use of modelled and real time data—Simplifai has the ability to combine and interpret data from a range of modelled and real time sources to enable the system to understand the current and future status of the network.
Outputting to a range of systems—the output of Simplifai can link directly into traffic models (for off line testing prior to implementation), central control systems, directly to control equipment managing the network and to routing engines for connected and autonomous vehicles.
System re-planning—Simplifai can produce an updated set of traffic management plans in real time if the initial plan diverges from its intended plan. This can be undertaken at a re-planning refresh interval of 5 minutes of less.

1.1 Examples in Document

The examples of operation used in this document are presented to highlight the detailed operation of Simplifai in particular circumstances. More detail of the operation can be provided on request.

2 Technical Architecture

2.1 Strategy Generator

The purpose of the strategy generator 2 is to create a traffic management strategy and a set of control instructions for all infrastructure relevant to the strategy, that when enacted will achieve the desired goal. The goal is set in advance and can be anything from managing congestion to evacuating a city in the event of an emergency. The strategy generator is the main topic of this disclosure and is explained in full within section 3. The orchestration component 4 is responsible for initiating the strategy generator 2 and for providing access to the necessary data and systems.

2.2 Input Data Adaptors

The system operates using a series of input adaptors 6, which are driven by supervision and control applications particular to the operational environment. These adaptors 6 extract information securely from one or more data sources 8 and process it into the correct form for consumption by the strategy generator 2. This often requires translation, adaptation, combination, validation/verification and other forms of intermediate processing. Data sources 8 include traffic management and control systems, data aggregation hubs, databases, smart city data sources and sensors of any kind (including connected vehicles). Data can be provided manually (e.g. surveyed traffic counts). An instance of the system may use multiple input adaptors 6.

For example, one adaptor 6 uses surveyed traffic count data as a baseline for link occupancy. This data is collected manually and provided to the adaptor as a CSV file. The adaptor then uses real-time traffic data from a city's traffic monitoring system to adjust link baselines upwards or downwards using a factorising algorithm. The occupancy on links where there is no real-time monitoring is inferred by the occupancy on measured links to provide an approximation of likely real-time traffic, suitable for use by the strategy generator 2.

2.3 Output Data Adaptors

The purpose of the strategy generator is to produce a set of control instructions for all infrastructure relevant to the traffic management strategy, that when enacted will achieve the desired goal. The control instructions can be used in a number of operational environments, including connected vehicles, information signage, control room visualisation, transport modelling, traffic control and traffic simulation products and infrastructure. The format and content of these instructions varies with each operational environment and in some cases will vary with each vendor's product within an operational context. For example, Vendor A, Vendor B and Vendor C each provide traffic control systems, but the form and content of each vendor's input signal control instruction set is different. It is also possible for a client to customise their product implementation.

The purpose of an output adaptor 10 is to produce control instructions in a suitable format for use by a particular customer, with a particular product in a particular operational context. It takes control instructions from the strategy generator 2 and in combination with other relevant information and systems, creates control instructions that can be executed by the target product. This often requires translation, adaptation, combination, completion, validation/verification and other forms of intermediate processing. For real-time traffic control products, it turns control instructions into complete signal plans that can be loaded into the traffic control system, for example.

An instance of the system may use multiple output adaptors 10. For example, a ‘real-time signal control’ output adaptor would create signal plans for the urban traffic control system at the same time as a ‘control centre visualisation’ output adaptor creates signal instructions for a traffic model or geographic information system that is displayed in the control room.

2.4 Control Adaptors

Coordination with external systems requires both data and process control. Whilst the data adaptors 10 provide data in the appropriate format for integration with external software and infrastructure, control adaptors 12 provide process control facilities for use by a particular customer, with a particular product in a particular operational context.

In this context, process control can include:
Issuing the correct instruction, in the correct way, in the correct format, at the correct time to the correct system—i.e. talking to the output product using the appropriate protocols;
Determining the effect of an instruction through instrumentation and measurement, before during and after instructions have been issued; and
Determining that an instruction has been successful and responding to problems, including external problem reporting.

For example, when requesting that a signal controller end the current signal stage, the control adaptor 12 could check the current signal stage, issue the instruction and check the resulting signal stage. It would also record information about how long the process took, whether there were warnings or errors, etc. If there were errors, it would determine if they have to be acted upon and would act accordingly.

Each external system is likely to be proprietary and so can have one or more of its own control adaptors 12. It is common for a single product such as a traffic control system, to permit multiple methods of control (e.g. a Telnet/SSH interface, a RESTful API, a UTMC indirect control interface, etc.). In some cases, there is a common protocol (e.g. UG406 for urban traffic control) and so many control adaptors may share a ‘protocol’ output control adaptor. Equally, where proprietary systems use the same data format, they may share a data adaptor.

Control adaptors 12 can be used both for input (e.g. requesting real-time information about parking availability or traffic volume) and output (controlling signals, issuing routing guidance to connected vehicles, etc.). They may also have a user interface and may even be part of another product. For example, the traffic simulation control adaptor is embedded within the traffic modelling and simulation product, with a user interface that allows configuration and control of the adaptor.

2.5 Orchestration

A traffic management strategy is a coordinated set of interventions across multiple operational contexts and locations within the traffic network, that in combination allows a city to achieve its traffic management objectives within a particular timescale. Consequently, when the strategy generator produces a set of control instructions, they have to be orchestrated across systems in real-time, for a period of time, until the strategy is successful. The orchestration component 4 performs this function.

For example, it continuously compares real-time with anticipated traffic flows using input data adaptors 6 and the strategy generator's 2 simulator output so that it can trigger a new strategy when there is divergence. At the same time, it converts signal instructions into a collection of complete signal plans, which it must load, execute and unload in the correct sequence from dozens of traffic controllers using the traffic control computer. Meanwhile, it must provide accurate, timely information to the supervisory control environment in the traffic control centre.

The orchestration component 4 contains its own logic but relies heavily upon the input 6 and output 10 data adaptors, and the control adaptors 12, for integration to specific systems and adherence to specific protocols.

The importance of orchestration and control increases as the goal complexity increases and the size/complexity the network and its domain model increases.

2.6 Management Console

The system can operate as an integrated part of another management product, such as an urban traffic management system 14 within a control centre. In that context it provides a set of data and control interfaces that can be used by other systems to configure and control the system, or to present options and information to users.

However, many traffic authorities don't have this facility, or use a simple facility that may not be appropriate for autonomous city-wide control. For this reason, the system can include its own management console application 16. This architectural component is crucial in democratising traffic management and facilitating the widespread deployment of the system across customers, markets and territories.

The management console application 16 provides configuration, management, control, visualisation and reporting facilities that allow the strategy generator 2 to operate either as a decision support tool (human-initiated control) or as an autonomous traffic management product (system-initiated control). For example, a user could utilise this application to set a goal for the strategy generator 2, run the strategy generator, visualise the resulting strategy, execute the strategy, evaluate its effectiveness in real-time, stop the current strategy, generate a new strategy or report/evaluate its effectiveness post-completion. They could also configure operational parameters, adaptor integrations, data sources/sinks and security options.

2.7 Data

The data required by the system depends upon the traffic management goal, the operational context (e.g. traffic planning vs real-time control) and the operational environment (e.g. the presence or otherwise of a management console) for the system.

In many cases, data will be transient. It will be taken from source data repositories, processed, used and then discarded (except insofar as it is required for security, auditing and reporting). Data adaptors 6 perform the role of managing data access, processing data and then making it available to components within the system, such as control adaptors 12. Transient data can be stored temporarily and then purged from the system datastore as required. A discrete data management sub-component of the orchestration component can be responsible for data management.

In some cases, especially where data persists for a long time (e.g. traffic signal maximum and minimum green times, junction and link names/locations, etc), it can be stored in the system datastore and usually updated periodically.

Reporting and audit data can be stored permanently and archived according to customer, territory and legislature-specific policies.

Sensitive data is not usually stored within the system.

Data access is usually secured through a multi-layered security and access management framework, that can be a subcomponent of the orchestration component.

2.8 Security

Security is a key component of the system and for this reason a multi-layered security approach is usually used. System-related security measures for this system will typically include:
Application security—all end-points, components and interfaces require authentication and use user/service identity management
Access control—access to all layers of the architecture is controlled using individual, group, role and functional privileges, with administrator privileges restricted in number.
Protocol security—the system uses a variety of protocols, especially to access source data and infrastructure control environments. For example, access to traffic control systems are often via telnet or SSH, whereas access to city data hubs are often through secure http, file system protocols or even sftp. Where practicable, the secure variant of these protocols is used (e.g. SSH instead of Telnet, HTTPS instead of HTTP).
Network security—depending upon the operational context, varying degrees of network security are deployed. As a minimum, firewalls and intrusion detection systems are deployed.
Operating system security—access to the operating system is restricted to a limited number of named and audited individuals.
Physical security—access to the physical infrastructure required to operate the system restricted to a limited number of named and audited individuals and enacted through tier 1 data centres where possible.
Data security—data is encrypted at rest and during transfer. Only the minimum data required to operate the system is stored and even then, only for the minimum time possible. Sensitive data is not stored.
Maintenance—all software is maintained at the latest patch level or version.

3 Strategy Generator

3.1 Data Requirements

The strategy generator's 2 inputs are an initial state at some time T, a goal, a domain model, a time delay E. It outputs a Traffic Signal Strategy that if executed at time T+E will achieve the goal, assuming the initial state and domain model are accurate representations of the application.

An initial state is the set of all the data/knowledge about the traffic scenario (within a spatial target region of an urban area under consideration) that the strategy generator assumes is true at the start of the problem, and what it uses to help generate the strategy to solve the goal.

Typically only certain initial states are allowed. Appendix B attempts to capture those initial states by stating constraints on and among the components of an initial state.

This initial state is composed of two types of information as defined in the sections that follow.

One major advantage of this disclosure's approach is that strategies are automatically generated in response to a chosen Urban Traffic Control goal. This goal together with its initial state can itself be generated in real time to suit the kind of problem to be solved. For example, if the problem is to reduce pollution in a region containing several road links, the goal produced may be to lower the congestion of those road links.

If the strategy generator's 2 internal world model is correct/sufficiently accurate, then if it generates a strategy, it is guaranteed to solve the goal when executed. If independent simulation shows that it does not, then its internal model or its internal simulator is not correct or sufficiently accurate.

A domain model 20 (box 7 in FIG. 2) encodes the ‘physics’ of the traffic management scenario. In this example this models vehicle flows, signal changing actions, events, and inter-green processes. The domain model 20 has to be engineered by planning experts a priori. The model represents effects via traffic signal changes. There are various other ways of changing traffic flows (‘effectors’) such as VSL/VMS—these can be added to the strategy generator's domain model modularly, meaning that new strategies generated will contain instances of those effectors if they help achieve a goal.

3.1.1 Persistent Data

Persistent data 22 (box 1, FIG. 2) is collected or known before strategy-generation time, comprising:
1 a unique identifier for every link 40 (for example, the identifiers annotating the arrows in FIG. 3), junction (for example, the circles in FIG. 3), and junction stage 42 (parts of the cycle annotated stage 1,2,3 in FIG. 4 and FIG. 5), in the problem region. The set of all links is made up from a disjoint union of sets of links:
in-link U internal-link U out-link
2

In-links and out-links are collectively termed boundary-links and have one end which is outside the region under consideration. Otherwise a link is an internal-link.
3 maximum storage capacity of each link in pcu. All boundary links are assumed to have infinite capacity.
4 for each signalized junction:
   a the stage orders (fixed sequential ordering of stages, as in the clockwise order of stages 1-3 in FIG. 4 and FIG. 5)
   b the fixed intergreen timings 44 between stages (the time lengths of the orange part cycles in FIG. 4, with example timings given in FIG. 5)
   c the recommended maximum cycle time of the junction (the time length of the cycle FIG. 5 is 120 s.)
   d

Pedestrian crossings are considered signalized junctions modelled as having one stage (when traffic flows) and one intergreen (when pedestrians can cross).
5 for each stage in a signalized junction:
   a which turning movements (left, right & straight on) are shown a green signal during that stage (for an example junction topology in FIG. 4 and FIG. 5, the green arrows show which turning movements are valid for that stage)
   b minimum time of the stage
   c [optional] a maximum time of the stage. A special case is where stage times cannot be changed, and hence a maximum time can be set to be the same as the minimum time.
   d for each turn, the estimated maximum physical flow in pcu/s *for the turn during that stage*.
6 for each turn, an estimate of the the stage average flow in pcu/s typically for the period of time used for the plan (am peak, off peak, pm peak, special event etc) to be planned for, based on origin-destination of the traffic entering the region. This value will be used during pre-processing to extract the intentions of the vehicles from the simulation software.
7 for each turn in a non-signalized junction (represented as a signalized junction with one everlasting stage) the maximum flow in pcu/s
8

Note that the existence of a ‘turn’ at a junction means two named links are joined, and therefore implicitly gives the network topology of the targeted region.
9 for each in-link, the expected average flow rate in pcu/second feeding into that link. This can be ‘step-changed’ over periods of time (so for a link in, we may expect 1 pcu/s average for 120 seconds, then 0.5 pcu/s average for the next 60 seconds, etc). Out-links are assumed to act like sinks, so that traffic flows into them unimpeded from the end of the link inside the region.
10 a fixed plan stating for each junction, that is how many seconds green time each stage will be active before entering intertime. The fixed plan has a fixed cycle time, and a fixed set of split timings, and is assumed to be the plan active in the targeted region at time T when the strategy generator is invoked. In FIG. 5, this could be the values as shown: stage 1=50 seconds, stage 2=30 seconds, stage 3=18 seconds.
11 the goal is what the generated strategy has to achieve as efficiently as possible. It must be written as a logical term whose components are data that the generated strategy can change. In other words, possible goal components are those that can be defined in terms of the effects of a process, action or event in the domain model. An example goal might be to lower the occupancy of a set of links

3.1.2 Real-Time Data

Real-time data 24 (box 2 in FIG. 2) is data from the target region that is assumed to be collected in real time or near real time:
1 the number of vehicles (in pcu(s) on each link at time T
12 for each signalized junction, the identifier of the current green lit stage or intergreen active at time T, and the number of seconds elapsed since the beginning of that stage or intergreen.

3.2 The Workings of the Strategy Generator

The strategy generator generates split timings for junctions in the region of interest (for example, time lengths for each of the 3 green arcs of the cycle in FIG. 4 and FIG. 5). In contrast to the fixed time plan, these splits may vary over the time of the plan, as may the cycle time of a junction, within the limits of any given maximum cycle time.

This example assumes a stage of signals at a junction is defined as a distinct set of signals that are continuously showing green. Each stage is followed by a fixed length intergreen, of 0 or more seconds. There are some special cases: a filter arrow entails a 0 s intergreen time (the next stage starts immediately). A pedestrian crossing consists of 1 stage and 1 intergreen. A junction with no signals consists of 1 stage.

FIG. 5 shows a concrete example of a junction's cycle with sample timings. It also shows example stage configurations, where the green arrows are the flows allowed by the traffic signals for that stage. It can be seen, then, that a strategy that changes the lengths of stages changes the overall amount of flow through the possible routes that can be taken through that junction. For all junctions in the region, for each cycle over time, the strategy generator will produce a signal plan of split timings in order to achieve the goal it is given.

The strategy generator works in 2 phases, as described in sections 3.2.2 and 3.2.3. It is based on a simulation method which we describe in section 3.2.1.

3.2.1 Simulation

In order to generate a strategy to achieve the goal, and check that the strategy will achieve the goal, the strategy generator's planning engine 26 (box 6 in FIG. 2) must embody a simulator. This simulates the operation of a strategy on the initial state, using the active elements of the domain model—in other words using the processes, actions and events defined therein.

The simulation of the traffic world is digital; therefore, we need a unit (or, a ‘delta’) after which an incremental change will be simulated. In this case, we use delta=1 second intervals. The key flow value required for simulation is estimated as the volume of vehicles (in pcus) travelling along a route from link X to link Y through a junction. This actual flow rate (AFR) used in the planning engine's simulation is calculated at each time T. For calculating the AFR[T], we use the maximum physical flow rate (PFR) as the root.

AFR[T] is calculated from the application of the following functions to PFR:

AFR[T]=PFR×G1×G2×G3×G4×G5

Where:

G1=factor derived from saturation of X at time T

G2=factor derived from saturation of Y at time T

G3=factor derived from any cross flows of X to Y (e.g. if X to Y is a right turn) at time T

G4=factor derived from intentions of drivers, extracted from the stage average turn rate (Section 1.d)

G5=length of time the stage has been activated at time T

Given the AFR is calculated thus at time T in state S(T), we can specify the simulator by specifying what changes it makes to the State at time T, given a generated (or pre-defined) strategy P.
1 From P, collect all the actions that must be executed from state S(T) (i.e. timed to execute at T) then sequentially execute them. The sequence of execution of each action must make no difference to the effect. Let the resulting updated state=S1(T).
13 Run the procedure Events(S1(T),S2(T)).
14 Collect all the processes from the domain model that have their preconditions satisfied in state S2 then sequentially execute them for Delta time. The sequence of execution of each process must make no difference. Additionally, no events' preconditions can become true during Delta then become false again. Let the resulting updated state=S3(T+Delta).
15 Run the procedure Events(S3(T+Delta),S4(T+Delta)).

The procedure Events(s,t) inputs a state s and outputs a state t, as follows:
1 Collect all the events from the Domain Model that have their preconditions satisfied in state s then sequentially execute them. The sequence of execution of each event must make no difference to the effect. Let the resulting updated state=s1.
16 IF s/=s1 THEN set s:=s1 and goto a; ELSE set t:=s1.
17 end

For the full simulation, we iterate through this procedure starting with T=0, replacing S with S4(T+Delta) and T with T+Delta after each run, until we have reached the end of P.

3.2.2 Preprocessing

The strategy generator's inputs (the initial state and goal, and domain model) can be pre-processed 28 (box 3 in FIG. 2) in order to:
provide a form of static validation which checks the integrity or otherwise of the input data;
optimise their representation, making explicit information within the problem that the strategy generator may need to use multiple times; and
transform the inputs into a more efficient representation involving reduction of dimensions on predicate arguments.

3.2.2.1 Step 1

This checks that the invariants given in the Appendix B are all met. If any are violated, then the strategy generated may be unreliable in this example.

3.2.2.2 Step 2

For every junction and link, the following are calculated;

Let C be any allowed set of timings for stages in a signalized junction (i.e. set of stage time lengths that are between the max and min allowed); L,L1,L2 links, and j a junction. Then we calculate the following using simulated flow values from data 3.1.1-4(d) above (i.e. where the flows are the estimated maximum flow values for the period under simulation):

F1_j(L1,C)=the average outflow over C emerging from the end of link L1 through j;

This is the amount of traffic that escapes from L1 on average over the whole of the cycle C as specified.

F2_j(L2,C)=average inflow into the start of L2 through j over the whole of the cycle C;

F3_j(L1,L2,C)=average inflow over cycle C from link L1 into the start of L2

Note we have the connection that that the sum over all links L leading into L2 (i.e. sum of F3_j(L,L2,C) over all L) is equal to F2_j(L2,C).

Then we can calculate the ‘average fill-up rate’ of a link L as:

F2_j(L,C)−F1_k(L,C1)

where L is a link from junction j to junction k, and C1 is any allowed set of timings for stages in junction k.

Given these definitions we can calculate the main expected flow corridors through the region from an in-link to an out-link, where the majority of vehicles proceed.

There are three sets of outputs from step 2 as follows;
Output 1
The first step is, for any given junction j, to calculate the timings of stages which maximize the flow out of a particular link L that feeds into j. We call this set of timings Cmax(L). Note we do not need to refer explicitly to ‘j’ as we assume every link flows into a unique junction.

In the context of the presence of a maximum cycle time for each junction (rather than using maximum timing for each stage, as carried out in our earlier work; If there are maximum timings for individual stages, as well as a maximum cycle time, then the calculation of optimum stage timings is more detailed.) Cmax(L) is calculated by maximizing the stage time of the stage with the largest flow out, and minimizing the rest:

To determine a stage time of s in Cmax(L):

IF s guarantees the greatest flow out of L THEN

Stage time of s:=(maximum cycle time)−(addition of minimum timing of all other stages)−(addition of all inter green times)

ELSE

Stage time of s:=minimum stage time of s.

So for example if we have a max stage time of 120, 3 intergreens of 10 s and mins of 10 s for each of 3 stages s1,s2,s3, and flow out of L during s1=1.0 pcu/s, s2=0.9 pcu/s and s3=0.1 pcu/s, then Cmax(L) is: Stage time of s1=70 s, Stage time of s2=10 s, Stage time of s3=10 s, and hence the average outflow of L over a cycle under Cmax(L) will be 0.666 pcus/second.

The pre-processor calculates Cmax(L) for each link L.
Output 2

Given a link L1, the pre-processor calculates the ‘goal corridor’ from L1—this is the list of links which traces the largest expected flow from L1 through the network to a out-link (which is considered to act as a sink), using junction stage timings that give the maximum flow out of each link, calculated in output 1 above.

To calculate the goal corridor from L1 which flows into junction j1, use the following procedure:

1. WHILE L1 is not an out-link:

2. identify L2, the next link in the corridor, where F3_j1(L1,L2,Cmax(L1)) maximizes function F3_j1(L1,LX,C), with LX ranging through all the links flowing out of j1.

3. set L1:=L2

4. END WHILE

Hence, each link is in the goal corridor because it is the link that receives the highest average flow over a cycle from its predecessor.
Output 3

Given a link, the pre-processor calculates all the bottlenecks along a goal corridor, that is the set of links where the average fill-up rate (defined above) is positive.

3.2.2.3 Step 3

This algorithm shows how the reformulation of a domain model Do and an initial state and goal expression Iₒ is performed. Beside the models to be reformulated, the algorithm requires as input a sparsity threshold sₜ which is used to decide whether or not it is useful to perform the reformulation and a parameter at which sets the maximum number of variables considered in the reformulation.

The output is a new domain(Do) and problem(Ir) description with a reduced dimensionality, which makes the use of strategy generation software more efficient.

We consider predicates of a domain model as static if instances of the predicate cannot be deleted or created during the planning process but, in the case of numeric predicates, their value can be changed. The sparsity of the predicates (boolean or numeric) with arity greater than 2 are assessed in turn (line 3) to determine if they are suitable for the reformulation step. As a measure of sparsity, we compare the set of propositions in the initial state with the possible set of all propositions for the predicate.

Input: Dₒ, Iₒ, sₜ , aₜ
Output: Dᵣ ,Iᵣ

| | |
|---|---|
| 1 | SP = statics(Dₒ ); P = predicates(Dₒ )∪functions(Dₒ) |
| 2 | Dr = Do ; Ir = Io |
| 3 | FOR ALL pj in P , where arity(pj ) > 2 DO |

| | |
|---|---|
| 4 | IF sparsity(pj , Io ) > st THEN |

| | |
|---|---|
| 5 | pstat = findConstrainingStatic(pj,SP) |
| 6 | IF pstat neq None THEN |

| | |
|---|---|
| 7 | Tp stat = getSparseVariables(pstat ,Io,at) |
| 8 | Cnew =makeConstants(Tpstat , so ) |
| 9 | Dr = addAsConstants(Dr , Cnew ) |
| 10 | Dr = updateOpProEv(Dr , Tpstat , Cnew ) |
| 11 | Ir = updatePredsFuncs(Dr,Ir,Tpstat ,Cnew ) |

| | |
|---|---|
| 12 | END IF |

| | |
|---|---|
| 13 | END IF |

| | |
|---|---|
| 14 | END FOR |

In the case of a sparse predicate pj the procedure attempts (line 5) to find a static predicate pstat such that pj is only used in transition schemas (that is in the action, process or event schemas) with pstat. If there is more than one constraining static predicate, then one is selected heuristically by selecting the predicate that occurs the most in transition schemas.

3.2.3 Heuristic for Strategy Generation

The strategy generation process is based on a search space of future states of the world, starting at the initial state. Future states are generated using the simulator explained in section 3.2.1. There exist a range of “automated planning engines” (box 6 in FIG. 2) in the academic literature that accomplish this for hybrid (i.e. discrete and continuous) formulations. Most of these hybrid planning engines input a language equivalent to a community accepted syntax called PDDL+.

To make strategy generation efficient and effective in any large hybrid application, however, we need to generate a “heuristic” for the application 30 (box 5 in FIG. 2), to use to guide the search in this search space. A heuristic helps guide the search, but it is not a hard rule, i.e. the search will try first those states for which the heuristic gives the lowest values, but if a solution is not found, it will progressively try states with higher values until a solution is found. For this declaration, any hybrid AI Planner can be used in the method, as long as it allows such a domain—dependent heuristic to be inserted in its search strategy, and it is powerful enough to input domain models equivalent to PDDL+.

There are published accounts of domain-specific heuristics for discrete-continuous planning-based urban traffic control. In particular, the queue-based heuristic was introduced in AAAI paper “Efficient macroscopic urban traffic models for reducing congestion: a PDDL+planning approach” (2 of the co-authors are authors of this disclosure). Such a heuristic is based on relaxing the constraints that vehicles can leave a link only when the corresponding traffic signal is green.

This disclosure defines a family of corridor heuristics to provide search space guidance to the strategy generator. None of the published heuristics however are as effective as the corridor family of heuristics.

3.2.3.1 General Formulation of Corridor Heuristics

The corridor heuristics are aimed at generating strategies for goals concerning the lowering of the occupancy of a link or of a set of links. For a link L1 in this goal set, the first step in the process is to generate the goal corridor of L1, as defined above in the pre-processor section, consisting of junctions j1 . . . jN and Links L1 . . . LN:

L1−j1−L2−j2−L3− . . . −LN−jN

where for each junction j we have cycle Cmax(Lj) operating.

This cycle assignment will lead to bottlenecks, however, as some links will become saturated.

Hence, the heuristic we require will be equivalent to an assignment of adjusted cycles C1, . . . CN under the constraints:

$$F2\_j1 ( L 2 , C 1 ) - F1\_j2 ( L 2 , C 2 ) < E 1$$

$$F2\_j2 ( L 3 , C 2 ) - F1\_j3 ( L 3 , C 3 ) < E 2$$

$$F2\_j3 ( L 4 , C 3 ) - F1\_j4 ( L 4 , C 4 ) < E 3$$

$$… . \\ F2\_jN - 1 ( LN , CN - 1 ) - F1\_jN ( LN , CN ) < EN$$

where EI,1 1=<I=<N, is the allowed extra flow into a link LI+1, taking into account the length of LI+1

Where we have a set of links to be lowered in the Goal, we can sum the individual values of the heuristic for each link in the set.

3.2.3.2 Specific Corridor Heuristics

A heuristic that can be generated very efficiently, can be calculated as follows:
3 Calculate the bottlenecks of the corridor. Note that there can be several bottlenecks, each of them affecting all links in the corridor which are closest to the goal than the corresponding bottleneck. Assume the first bottleneck is in link Lk, where we have:

L1−j1−L2−j2−L3− . . . Lk−1−jk−1−Lk−jk
4 Adjust the cycle times in the goal corridor for the junctions j1 to jk−1 so that the maximum average flow is never bigger than the bottleneck. This is achieved by lowering the maximised stage times in the goal junctions up to jk−1. This is implemented by reducing the time of the stage with the biggest average flow.

This is an approximation to the general formulation above. The distance from the bottleneck to any link ‘upstream’ does matter, e.g. a link which is a direct neighbour should reduce its average flow to exactly the pcus the bottleneck can take. However, if there is more than one link distance, reduction of flow should be adjusted to take into account that not all vehicles will actually make it to the bottleneck. For example, if we have corridor links L1, L2 and L3, L3 is the bottleneck, and L1->L2->L3, then the effect of L3 in reducing corridor output flow of L1 is ameliorated by the fact that cars leaving L1 to L2 might actually not make it to L3 because they are leaving the corridor.

These corridor heuristics are under constrained, which means that there are choices on how the maximised timings at each junction are calculated. Hence, they can be adjusted to take into account other constraints on the region, such as the need to provide a minimum cross corridor flow over some junctions, or where we have more than one link in the goal set.

3.2.3.3 Specific Corridor Heuristic: The Penalty-Based Corridor Heuristic

It is an extension of the corridor heuristic. It adds a penalty to the calculation of the heuristic for any state found whose goal(s) stage times are past the corridor heuristic regulated values. This way, search will always test first state(s) whose goal junctions are not sending more flow through than what the bottleneck can process on average.

3.2.3.4 Specific Corridor Heuristic: The Expanded Penalty-Based Corridor Heuristic

This is the current version of the corridor heuristic. We penalize not only states whose goal junction phases are past the corridor heuristic times, we also penalize if any of the corridor's junction phases are past their corresponding time values (as if we assessed them with the same corridor-based heuristic methodology we used for the goal(s) junctions).

3.3 Interface Specification for the Output Strategy

The strategy generated by Strategy Generator will be post-processed 32 (box 8 in FIG. 2) into a convenient format, and output to file 34 (box 9 in FIG. 2). Processes requiring this generated strategy will read it from this file. The format of the strategy is given below. In summary, it specifies stage time changes, i.e. when to move on from the current stage, for all of the signalized junctions (excluding pedestrian crossings, which are assumed to have fixed stage times).

The syntax of the control strategy is as follows. The file is a list of lines of the form:

<action number><time><stage id>

e.g.

11 140 s1202_s4

This means at <time>=T+E+140 seconds (140 seconds from the start of the strategy) move the signal at stage <stage_id>=s1202_s4 on to the next stage (the next stage will be reached after a specified intergreen time, of course). The <stage id> is unique to a particular junction, hence there is no need to include the junction identifier here. The action number here=11.

An external simulator that inputs this strategy, progresses its simulation using only these signal changing actions in the region (the strategy should direct every signal change). At the end of the signal strategy, the simulator should revert to its default strategy.

A short strategy for a region containing two junctions (N1202 and N1349, with specification below) which starts when the greentime for stage s0=0 at both junctions, using this syntax, is:

1 20 s1202_s0

2 30 s1349_s0

3 30 s1202_s1

4 40 s1349_s1

5 40 s1202_s2

6 60 s1202_s3

At the end of this example strategy, at 60 seconds, both junctions return to the default strategy. Hence 1202 (which is beginning stage s4 at the end of the strategy) will run through stage s4 until the default strategy tells it to change.

At the end of the strategy, as 1349 is 15 seconds into stage s2 (taking into account 5 seconds of intergreen after s1), it will run until the default strategy tells it to change if the strategy says greentime for this stage is greater than 15 seconds. If the default strategy says greentime for this stage is less than or equal to 15 seconds, then it will immediately switch N1349 to stage s3 at the end of the strategy.

Specification of the junctions involved in the example are as follows:

((interlimit S1202_s0) 0)

((interlimit S1202_s1) 0)

((interlimit S1202_s2) 0)

((interlimit S1202_s3) 0)

((interlimit S1202_s4) 5)

((interlimit S1202_s5) 0)

((interlimit S1202_s6) 5)

((greentime N1202) 0)

((intertime N1202) 0)

((mingreentime S1202_s0) 5)

((mingreentime S1202_s1) 5)

((mingreentime S1202_s2) 0)

((mingreentime S1202_s3) 5)

((mingreentime S1202_s4) 5)

((mingreentime S1202_s5) 0)

((mingreentime S1202_s6) 5)

((maxgreentime S1202_s0) 40)

((maxgreentime S1202_s1) 20)

((maxgreentime S1202_s2) 10)

((maxgreentime S1202_s3) 60)

((maxgreentime S1202_s4) 70)

((maxgreentime S1202_s5) 15)

((maxgreentime S1202_s6) 50)

(active S1202_s0)

((interlimit S1349_s0) 5)

((interlimit S1349_s1) 5)

((interlimit S1349_s2) 10)

((interlimit S1349_s3) 10)

(_(greentime N1349) 0)

((intertime N1349) 0)

((mingreentime S1349_s0) 5)

((mingreentime S1349_s1) 5)

((mingreentime S1349_s2) 5)

((mingreentime S1349_s3) 10)

((maxgreentime S1349_s0) 70)

((maxgreentime S1349_s1) 70)

((maxgreentime S1349_s2) 70)

((maxgreentime S1349_s3) 75)

(active S1349_s0)

An explanation for some of these facts is as follows:

((interlimit S1202_s6) 5) means that the intergreen after stage S1202_s6 lasts for 5 seconds.

(_(greentime N1202) 0)

(=(intertime N1202) 0) means that the next stage at junction N1202 has not started yet.

(active S1202_s0) means that stage S1202_s0 is active, but it has just started (its elapsed green time is 0 seconds).

(_(mingreentime S1202_s0) 5) means that stage S1202_s0 must remain active for at least 5 seconds.

APPENDIX
A Glossary

| | |
|---|---|
| pcu | a standardised unit of vehicle |
| junction | a point where two or more links meet. A |
| | junction disrupts the traffic flow in that we |
| | need to define flows between links flowing |
| | into the junction to links flowing out of the |
| | junction [synonym: intersection]. |
| link | a road section with a junction at one end (its |
| | beginning) and a junction at another (its end). |
| | The traffic flow is uni-directional flowing |
| | from beginning to end. |
| the | the number of pcus in that link at time t. |
| occupancy of | Vehicles in that link can of course be either |
| a link at time | stationary or moving. |
| t | |
| the capacity | the maximum (physically) number of pcus that |
| of a link | could occupy a link |
| turn | traffic path across a junction from the end of |
| | one link to the start of another link. A turn is |
| | “on” means traffic are allowed across this |
| | path. |
| turnrate | a transfer rate in pcus per second through a |
| | turn in a junction, written X −> Y. |
| flow out of a | the addition of all the flows across turns |
| link X during | leading out of X over the period of time of |
| a stage s | stage s |
| Stage (of | a distinct set of signals at a junction which are |
| traffic | continuously showing green all at the same |
| signals) | time. |
| | This set of signals stays constant through the |
| | stage (if any signal changes, we say that a new |
| | stage or an intergreen starts). This is |
| | equivalent to a set of turns being ‘on’. |
| | Example: Assume J is a junction and X and A |
| | are links with ends at junction J, while Y, Z, |
| | and B are links which have their beginning at |
| | junction J. Consider a stage with one signal |
| | allowing X −> Y, X −> Z, and another |
| | allowing and A −> B. Each of the three flows |
| | will have a turn-rate predefined. Let us focus |
| | on X −> Y, and say this turnrate is 1 pcu/s. |
| | Assume the occupancy of X is N and the |
| | occupancy of Y is M. Then if N > 0, and M is |
| | less than the (capacity of Y) − 1, then in one |
| | second we assume that the effect of this |
| | turnrate on the occupancy of X is to remove 1 |
| | pcu, and the effect on the occupancy of Y is |
| | to add 1 pcu. [NB of course at the same time |
| | other turnrates may cause the occupancy of X |
| | and of Y to vary also]. |
| controllable | those junctions which have traffic signals such |
| junctions | that the greentime of each signal can be |
| | controlled by the AI planning engine. |
| intergreen | the time between two consecutive stages when |
| | no when no vehicular light is on green. This |
| | could be 0. For example, we model the effect |
| | of a filter arrow turning green as 2 stages, |
| | with a 0 second intergreen. |
| green time | for a stage is the least amount of continuous |
| | time in seconds that the stage can be on |
| | green. |
| maximum | for a stage is the greatest amount of |
| green time | continuous time in seconds that the stage can |
| | be on green. |
| stage orders | the fixed order in which the stages progress. |
| SCOOT | a set of junctions that are controlled co- |
| region | operatively by the SCOOT control |
| | mechanism. |

B Invariants

These expressions have to be true of any initial state file generated from the information entering the AI Core (FIG. 2). Firstly, links are formed from the disjoint union of sets of links: in-link U internal-link in U out-link

Every link has an occupancy value, and this is always smaller than the maximum physical occupancy of that link:

∀x∈ link,∃!y∈R∃!z∈R(=(occupancy x)y)&(=(max_occupancy x)z)& y=<z
Every stage is followed by an intergreen stage of a certain length y:

∀x∈ stage,∃!y∈N((interlimit x)y)
Every stage of a signalized junction has one stage before it and after it:

∀x∈ stage of a signalised junction:∃!y,z∈stage, (next y x)&(next×z)
Every stage belongs to exactly one junction:

∀x∈ stage,∃!y∈ junction(contains y x)
Every junction has a greentine—the number of seconds the current stage has been on.

∀x∈ junction,E!y∈N(=(greentime x)y)
Every junction has an intergreentine−the number of seconds the current intergreen has been on.

∀x∈ junction,∃!y∈N(=(intertime x)y)
Every junction has a stage that is active:

∀x∈ junction ∃!y∈ stage, (active y)&(contains x y)
Every inside link has at least one other link that flows into it:

∀x∈ internal-link,∃y∈ stage,∃z∈ link,∃v∈R(=(turnrate y z x)v)

1: A traffic strategy and/or management system suitable for generating and/or implementing one or more strategy options which achieve a goal set by the user, said system including orchestration means connected to;
at least one data source means,
at least one infrastructure means; and
at least one management or control means
characterised in that said orchestration means is also connected to a strategy generation means, said strategy generation means configured to create at least one traffic management strategy and/or a set of control instructions for all infrastructure means relevant to the strategy to achieve a goal set by the user, wherein said data source means includes modelled data and real time data which are supplied and utilised by the strategy generation means and received via the orchestration means to create at least one traffic management strategy and/or a set of control instructions in real time and/or near real time.

2: A traffic strategy and/or management system according to claim 1 characterised in that the traffic is road based traffic.

3: A traffic strategy and/or management system according to claim 1 characterised in that the data source means include any one or any combination of traffic management and control systems, data aggregation hubs, databases, smart city data sources and sensors of any kind, including connected vehicles and sensors thereof.

4: A traffic strategy and/or management system according to claim 3 characterised in that the system uses multiple data input means.

5: A traffic strategy and/or management system according to claim 4 characterised in that the system includes one or more input data adaptors said input adaptors collect and/or process information from the at least one data source means into the correct form for use by the strategy generation means.

6. (canceled)

7: A traffic strategy and/or management system according to claim 1 characterised in that the system includes one or more output data adaptors, said output adaptors processing control instructions from the strategy generation means into a format for use and/or execution by the infrastructure means.

8. (canceled)

9: A traffic strategy and/or management system according to claim 1 characterised in that the infrastructure means includes real-time traffic control products.

10. (canceled)

11: A traffic strategy and/or management system according to claim 1 characterised in that the system includes one or more process control adaptors situated to control instruction and/or data flow into and/or out of the orchestration means.

12-17. (canceled)

18: A traffic strategy and/or management system according to claim 1 characterised in that the orchestration means orchestrates the set of control instructions produced by the strategy generation means across the components or means of the system.

19: A traffic strategy and/or management system according to claim 18 characterised in that the orchestration includes collection, coordination, and/or sending instructions from the strategy generation means to at least the infrastructure means.

20: A traffic strategy and/or management system according to claim 19 characterised in that the orchestration is in real-time.

21-23. (canceled)

24: A traffic strategy and/or management system according to claim 18 characterised in that the orchestration means converts signal instructions into a collection of signal plans.

25: A traffic strategy and/or management system according to claim 24 characterised in that the orchestration means converts signal instructions into a collection of complete signal plans, which it can load, execute and unload from single or multiple traffic controllers using a traffic control computer.

26-31. (canceled)

32: A traffic strategy and/or management system according to claim 1 characterised in that the strategy generation means inputs include an initial state at some time (T), a goal, a domain model, and a time delay (E) and the strategy generation means outputs a traffic signal strategy that if said strategy is executed at time T+E to the initial state, to achieve the goal.

33: A traffic strategy and/or management system according to claim 32 characterised in that an initial state is the set of all the data/knowledge about the traffic scenario within a spatial target region of an area under consideration.

34: A traffic strategy and/or management system according to claim 33 characterised in that only certain or predetermined initial states are allowed, said initial states comprising at least two types of information, persistent data and real time data wherein persistent data is collected or known before strategy generation and real-time data is data from the target region that is collected instantaneously, in real time or near real time.

35-42. (canceled)

43: A traffic strategy and/or management system according to claim 1 characterised in that the strategy generation means works in two phases, a pre-processing phase and a heuristic phase.

44: A traffic strategy and/or management system according to claim 43 characterised in that to generate a strategy to achieve the goal, and check that the strategy will achieve the goal, the strategy generation means includes a simulator or a planning engine that includes a simulator.

45-46. (canceled)
